(19) United States
(12) Patent Application Publication
(10) Pub. No.: US 2026/0171914 A1
(43) Pub. Date: Jun. 18, 2026

(54) MULTI-MODE POWER CIRCUIT FOR EFFICIENT OPERATION AT MULTIPLE POWER LEVELS AND RELATED METHODS

(71) Applicant: QUALCOMM Incorporated, San Diego, CA (US)

(72) Inventors: Chethan Devaraj, Bangalore (IN); Subbarao Lanka, Bangalore (IN); Shruti Hanumanthaiah, Bangalore (IN)

(21) Appl. No.: 18/973,577

(22) Filed: Dec. 9, 2024

(51) Int. Cl. H02M 3/158; G06F 1/16

(52) U.S. Cl. CPC H02M 3/158; G06F 1/163

(57) ABSTRACT

In a power supply circuit, such as a switched-mode power supply circuit, the rate at which a capacitor is charged during a charging mode depends on inductance of the power supply circuit, which may be selected for efficiency to support a particular power consumption rate. An exemplary power supply circuit includes a power management circuit to control dynamic selection of a first operation mode employing a first inductor having a first inductance for power efficiency at a first power supply rate and a second operation mode employing a second inductor for power efficiency at a second power supply rate. In some examples, the power management circuit couples the second inductor in parallel with the first inductor to provide a second inductance in the second operation mode.

### TECHNICAL FIELD

The technology of the disclosure relates generally to providing power to integrated circuits (ICs) and, in particular, to efficiently providing power at multiple power levels according to circuit demands.

### BACKGROUND

An integrated circuit (IC) that provides a commonly used function may be re-used in multiple devices to provide a cost savings to device manufacturers. A power supply circuit, for example, which may include a power management IC (PMIC), may be employed in devices that have different levels of power consumption because the processing circuits in different devices may have different data processing requirements. A power supply circuit may also be employed in a single device, such as augmented reality (AR)/virtual reality (VR) devices, which may both be referred to as extended reality (XR) devices (e.g., glasses or goggles), that operates in different modes having different power consumption requirements. Power circuits can be optimized to provide power more efficiently at a target power level, but a power circuit that provides different levels of power in different devices or different modes of operation may be most efficient at one level and less efficient at other levels. Because power efficiency can affect the battery life and user experience in battery operated devices, such as XR devices, efficient operation of a power circuit at multiple power levels would be beneficial.

### SUMMARY

Aspects disclosed in the detailed description include multi-mode power circuits for efficient operation at multiple power levels. Related methods of providing power efficiently at multiple power levels are also disclosed. In a power supply circuit, such as a switched-mode power supply circuit, the rate at which a capacitor is charged during a charging mode depends on inductance of the power supply circuit, which may be selected for efficiency to support a particular power consumption rate. An exemplary power supply circuit includes a power management circuit to control dynamic selection of a first operation mode employing a first inductor having a first inductance for power efficiency at a first power supply rate and a second operation mode employing a second inductor for power efficiency at a second power supply rate. In some examples, the power management circuit couples the second inductor in parallel with the first inductor to provide a second inductance in the second operation mode.

In this regard in one aspect, an IC integrated circuit (IC), including a power supply circuit is disclosed. The power supply circuit includes a power management circuit configured to conduct a first current through a first node, a first inductor coupled between the first node and a load node, a second inductor coupled between the first node and the load node, and a capacitor coupled between the load node and a reference voltage node. The power management circuit is configured to, in a first operation mode, generate the first current through the first inductor to the load node; and in a second operation mode, generate at least a portion of the first current through the second inductor to the load node.

In another aspect, a method of a power supply circuit is disclosed. The method includes, in a first mode, providing a first current to a load node through a first inductor coupled between a first terminal of a power management circuit and the load node; and in a second mode, providing at least a portion of the first current through a second inductor coupled between the first terminal of the power management circuit and the load node; wherein the first current charges a capacitor coupled between the load node and a reference voltage node.

In another aspect, an extended reality (XR) device is disclosed. The XR device includes a viewing medium, a data processing circuit configured to generate optical data and display the optical data on the viewing medium, and a power supply circuit. The power supply circuit includes a power management circuit configured to generate a first current through a first terminal, a first inductor coupled between the first terminal and a load node; a second inductor coupled between the power management circuit and the load node; and a capacitor coupled between the load node and a reference voltage node. The power management circuit is configured to, in a first operation mode, generate the first current to the load node through the first inductor; in a second operation mode, generate at least a portion of the first current to the load node through the second inductor; and the processing circuit is coupled to the load node and configured to receive the first current.

### BRIEF DESCRIPTION OF THE DRAWINGS

FIG. 1 is a schematic diagram of an integrated circuit (IC) including a switched mode power supply circuit for transferring power from a direct current (DC) battery to a load circuit;

FIG. 2 is a schematic diagram of an exemplary IC including a power supply circuit to transfer power from a DC power supply to a load circuit with a first inductance in a first operation mode and with a second inductance in a second operation mode to achieve efficient operation in both operation modes;

FIG. 3 is a graphical representation of a rate of power consumption in the load circuit in FIG. 2 over time and indications of an operation mode employed in power supply circuit for more efficient operation during certain portions of the time;

FIG. 4 is a first extended reality (XR) device that includes a processing circuit and an IC as shown in FIG. 2 to increase efficiency in different operation modes;

FIG. 5 is a second XR device that includes a processing circuit and an IC as shown in FIG. 2 to increase efficiency in different operation modes;

FIG. 6 is flowchart of a method of a power supply circuit in an IC according to FIG. 2;

FIG. 7 is a block diagram of an exemplary wireless communication device that includes a power supply circuit to transfer power from a DC power supply to a load circuit with a first inductance in a first operation mode and with a second inductance in a second operation mode to achieve efficient operation in both operation modes; and

FIG. 8 is a block diagram of an exemplary processor-based system that can include a power supply circuit to transfer power from a DC power supply to a load circuit with a first inductance in a first operation mode and with a second inductance in a second operation mode to achieve efficient operation in both operation modes.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include multi-mode power circuits for efficient operation at multiple power levels. Related methods of providing power efficiently at multiple power levels are also disclosed. In a power supply circuit, such as a switched-mode power supply circuit, the rate at which a capacitor is charged during a charging mode depends on the inductance of the power supply circuit, which may be selected for efficiency to support a particular power consumption rate. An exemplary power supply circuit includes a power management circuit to control dynamic selection of a first operation mode employing a first inductor having a first inductance for power efficiency at a first power supply rate and a second operation mode employing a second inductor for power efficiency at a second power supply rate. In some examples, the power management circuit couples the second inductor in parallel with the first inductor to provide a second inductance in the second operation mode.

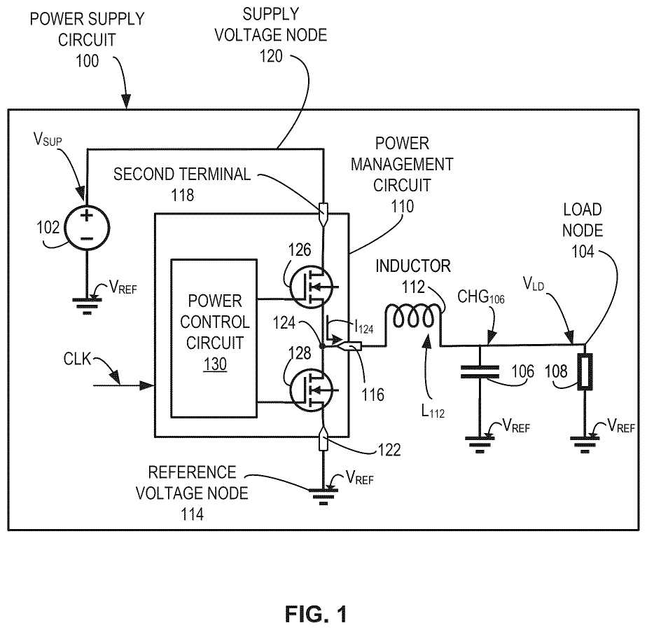

FIG. 1 is a schematic diagram of a power supply circuit 100, known as a switched mode power supply (SMPS), configured to transfer power from a direct current (DC) power supply 102 (e.g., battery) at a supply voltage V_{SUP}, to a load node 104 to charge a capacitor 106 to a load voltage V_{LD} to power a load circuit 108.

To facilitate a description of the operation of the power supply circuit 100, a description of the elements of the power supply circuit 100 is first presented with reference to FIG. 1. The power supply circuit 100 includes a power management circuit 110, an inductor 112, and the capacitor 106. The inductor 112 is coupled between the power management circuit 110 and the load node 104 and the capacitor 106 is coupled between the load node 104 and a reference voltage node 114.

The power management circuit 110 includes a first terminal 116 coupled to the inductor 112, a second terminal 118 coupled to a supply voltage node 120 of the DC power supply 102, and a third terminal 122 coupled to the reference voltage node 114. The power management circuit 110 includes a first node 124 coupled to the first terminal 116, a first switch 126 coupled between the second terminal 118 and the first node 124, and a second switch 128 coupled between the first node 124 and the third terminal 122. The power management circuit 110 also includes a power control circuit 130 that generates signals to control the first switch 126 and the second switch 128.

The power supply circuit 100 operates in either a charging mode or a discharging mode. In the charging mode, the power control circuit 130 controls the first switch 126 to couple the supply voltage node 120 of the DC power supply 102 to the first node 124 (e.g., through the second terminal 118) and controls the second switch 128 to uncouple (e.g., disconnect) the first node 124 from the reference voltage node 114 (e.g., through the third terminal 122). In a discharging mode, the power control circuit 130 controls the first switch 126 to uncouple the supply voltage node 120 from the first node 124 and controls the second switch 128 to couple the first node 124 to the reference voltage node 114.

The power supply circuit 100 alternates between the charging mode and the discharging mode in a periodic manner. In the charging mode, with the first node 124 coupled to the supply voltage node 120, a voltage is applied across the inductor 112, which causes a current to flow through the first node 124 and the first terminal 116 to the load node 104. As is known in the art, a current I₁₂₄ through the inductor 112 increases linearly while a voltage is applied (e.g., during the charging mode). In this manner, the charge CHG₁₀₆ is developed on the capacitor 106, which increases the load voltage V_{LD} on the load node 104. The load circuit 108 is powered by the charge CHG₁₀₆ on the load node 104.

In the discharging mode, the first switch 126 is opened to uncouple the first node 124 from the supply voltage node 120, and the second switch 128 is closed to couple the first node 124 to the reference voltage node 114. In this mode, the voltage across the inductor 112 is reversed, causing the energy stored in the inductor 112 during the charging mode to decrease and causing the current I₁₂₄ to decrease. When the next charging mode begins, the current I₁₂₄ begins to rise again. In each period of operation, the capacitor 106 is charged in the charging mode and depleted during the discharging mode. This cycle of charging and discharging is repeated each period of a clock signal CLK, which is received in the power management circuit 110. By alternating between the charging mode and the discharging mode with appropriate timing (e.g., duty cycle), the current I₁₂₄ through the first node 124 is controlled to generate the desired charge CHG₁₀₆ on the capacitor 106 needed to power the load circuit 108.

The desired amount of charge CHG₁₀₆ on the capacitor 106 in each period is based on an amount of power that is expected to be consumed by the load circuit 108 during the discharging mode. The charge CHG₁₀₆ developed on the load node 104 in the charging mode depends on the rate at which the current I₁₂₄ increases during the charging mode and the duration of the charging mode. Therefore, the rate at which the current I₁₂₄ increases depends on factors including an inductance L₁₁₂ of the inductor 112. The inductance L₁₁₂ may be optimized for power efficiency in the load circuit 208. Other factors affecting the selection of the inductance L₁₁₂ include the supply voltage V_{SUP}, the ripple current, the period of the clock signal CLK, and the duty cycles of the charging mode and the discharging mode. Assuming other factors remain the same, the current I₁₂₄ will increase at a faster rate and provide a required charge CHG₁₀₆ to the load in a given time when the inductor 112 has a lower inductance L₁₁₂. The rate of change of current I₁₂₄, and therefore the charge CHG₁₀₆, provided to the load for a given time is lower when the inductance L₁₁₂ is higher (assuming other factors remain the same).

Since the selection of inductance L₁₁₂ is based on an expected load transient requirement of the load circuit 108, the power supply circuit 100 can be optimized for efficiency if the transient requirement is known. However, typically the inductance L₁₁₂ is chosen to meet specific transient current requirements and efficiency. Sizing the inductor for high transient response (e.g., lower inductance) will result in poor efficiency at low currents due to increased output current ripple. On the contrary, sizing the inductance L₁₁₂ for best output power efficiency (e.g., higher inductance) will result in poor transient performance.

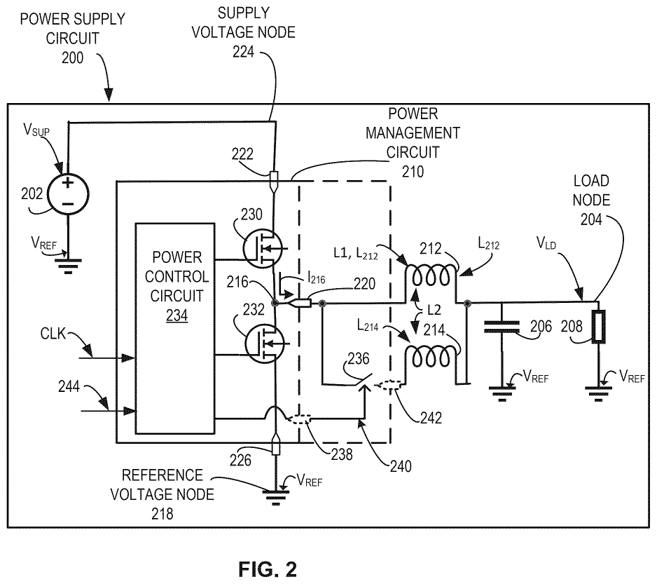

FIG. 2 is a schematic diagram of a power supply circuit 200 configured to transfer power from a DC power supply 202 to a load node 204 of a capacitor 206 through a first inductance L1 based on a first expected power consumption by a load circuit 208 and through a second inductance L2 based on a second expected power consumption by the load circuit 208. The first inductance L1 and the second inductance L2 may be selected for efficient operation at two different levels of power consumption in the load circuit 208.

To facilitate a description of the operation of the power supply circuit 200, a description of the elements of the power supply circuit 200 is first presented with reference to FIG. 2.

The power supply circuit 200 includes a power management circuit 210, a first inductor 212, a second inductor 214, and the capacitor 206. The first inductor 212 and the second inductor 214 are coupled between the power management circuit 210 and the load node 204. Specifically, the first inductor 212 and the second inductor 214 are coupled between a first node 216 in the power management circuit 210 and the load node 204. The capacitor 206 is coupled between the load node 204 and a reference voltage node 218. The power management circuit 210 includes a first terminal 220 coupled to the first inductor 212, a second terminal 222 coupled to a supply voltage node 224 of the DC power supply 202, and a third terminal 226 coupled to the reference voltage node 218. The power management circuit 210 includes the first node 216 coupled to the first terminal 220, a first switch 230 coupled between the second terminal 222 and the first node 216, and a second switch 232 coupled between the first node 216 and the third terminal 226. The first switch 230 may selectively couple the supply voltage node 224 to the first node 216 and the second switch 232 may selectively couple the first node 216 to the reference voltage node 218. The power management circuit 210 also includes a power control circuit 234 that generates signals to control the first switch 230 and the second switch 232.

The power supply circuit 200 also includes a third switch 236. In some examples, the third switch 236 is external to the power management circuit 210 and is coupled between the first terminal 220 of the power management circuit 210 and the second inductor 214. The third switch 236 may selectively couple the second inductor 214 to the first terminal 220. The power management circuit also includes a fourth terminal 238 and, in such examples, the fourth terminal 238 is coupled to the third switch 236. The power control circuit 234 in the power management circuit 210 generates a switch control signal 240 through the fourth terminal 238 to control operation of the third switch 236.

In alternative examples, the third switch 236 is internal to the power management circuit 210 where the third switch 236 is coupled between the first node 216 and a fourth terminal 242 and may selectively couple the first node 216 to the fourth terminal 242. In such examples, the first terminal 220 is coupled to the first inductor 212 and the fourth terminal 242 is coupled to the second inductor 214. The second inductor 214 is coupled between the fourth terminal 242 and the load node 204.

The power supply circuit 200 operates in either a charging mode or a discharging mode. In the charging mode, the power control circuit 234 may control the first switch 230 to couple the supply voltage node 224 of the DC power supply 202 to the first node 216 (through the second terminal 222) and controls the second switch 232 to uncouple (e.g., disconnect) the first node 216 from the reference voltage node 218 (e.g., the third terminal 226.) In a discharging mode, the power control circuit 234 may control the first switch 230 to uncouple the supply voltage node 224 from the first node 216 and control the second switch 232 to couple the first node 216 to the reference voltage node 218.

The power supply circuit 100 alternates between the charging mode and the discharging mode in a periodic manner. That is, in each period of a clock signal CLK, the charging mode is followed by the discharging mode. In the charging mode, a voltage is applied across the first inductor 212, which causes a first current I₂₁₆ to flow through the first node 216 and the first terminal 220 to the load node 204. In this manner, the charge CHG₂₀₆ increases on the capacitor 206 to provide the load voltage V_{LD} on the load node 204. The load circuit 208 receives power from the load node 204.

In the discharging mode, the first switch 230 is opened (e.g., off) to uncouple the first node 216 from the supply voltage node 224, and the second switch 232 is closed (e.g., on) to couple the first node 216 to the reference voltage node 218. In the discharging mode, a voltage across the inductor 112 is reversed, causing the energy stored in the inductor 212 during the charging mode to decrease and causing the current I₂₁₆ to decrease. When the next charging mode begins, the current I₂₁₆ begins to increase again. In each period of operation, the capacitor 206 is charged in the charging mode and depleted during the discharging mode. By alternating between the charging mode and the discharging mode with a particular duty cycle, which may be adjustable, the current I₂₀₆ through the first node 216 is controlled to generate the desired charge CHG₂₀₆ on the capacitor 206 that is needed to power the load circuit 208.

In an exemplary aspect, the power supply circuit 200 may be employed in a first operation mode in which the charge CHG₂₀₆ developed on the capacitor 206 is a first charge CHG1 or in a second operation mode in which the charge CHG₂₀₆ developed on the capacitor 206 is a second charge CHG2. In this manner, the power supply circuit 200 may be designed for efficient operation at two different levels of power consumption. The two levels of power consumption may be based on two different states of operation of the load circuit 208, or may be based on two different load circuits 208, which may be in two different devices.

While keeping the period of the clock signal CLK constant, different charges CHG1 and CHG2 may be achieved by controlling the first current I₂₁₆ that is conducted through the first node 216 during the charging mode. Controlling the first current I₂₁₆ includes controlling inductance between the first node 216 and the load node 204. In this regard, the power management circuit 210 may select either the first operation mode or the second operation mode by controlling the third switch 236.

In the examples in which the third switch 236 is external to the power management circuit 210, the power management circuit 210 controls the third switch 236 to uncouple the first terminal 220 from the second inductor 214 in the first operation mode and controls the third switch 236 to couple the first terminal 220 to the second inductor 214 in the second operation mode.

In the first operation mode, in such examples, the second inductor 214 is uncoupled from the first node 216, so the first current I₂₁₆ is conducted through the first inductor 212 to the load node 204. Specifically, the first current I₂₁₆ is conducted exclusively through the first inductor 212 to the load node 204, so the inductance of the power supply circuit 200 in the first operation mode is the first inductance L1 of the first inductor 212 (e.g., L₂₁₂).

In the second operation mode, the first inductor 212 and the second inductor 214 are both coupled to the first node 216, so the power management circuit 210 conducts the first current I₂₁₆ through the first inductor 212 and the second inductor 214 in parallel. The power management circuit 210 generates at least a portion of the first current I₂₁₆ through the second inductor 214 and that portion depends on the respective inductances (L₂₁₂ and L₂₁₄, respectively) of the first inductor 212 and the second inductor 214. The total inductance L2 of the first inductor 212 and the second inductor 214 in parallel is determined by the equation:

L2=1/(1/L₂₁₂+1/L₂₁₄)

In this manner, employing the first inductance L1 in the first operation mode and a second inductance L2 in the second operation mode may provide more efficient operation of the power supply circuit 200 in two different operation circumstances or applications in which there are different rates of power consumption in the load circuit 208.

In examples in which the third switch 236 is internal to the power management circuit 210, the first terminal 220 is coupled to the first node 216. In these examples, the first terminal 220 may be coupled directly to the first node 216. As noted above, the third switch 236 is coupled between the first node 216 and the second terminal 222. In these examples, in the first operation mode, the power management circuit 210 may control the third switch 236 to uncouple the first node 216 from the second terminal 222 and, in the second operation mode, control the third switch 236 to couple the first node 216 to the second terminal 222.

The power management circuit 210 may select either the first operation mode, in which the first inductor 212 having the first inductance L1 is employed to achieve a charge CHG1 on the load node 204, or the second operation mode in which the first inductor 212 and the second inductor 214 (in parallel) having a second inductance L2 are employed to achieve the second charge CHG2. The power management circuit 210 may select the first operation mode or the second operation mode based on an operation mode signal 244. The operation mode signal 244 indicates one of the first operation mode and the second operation mode. The operation mode signal 244 may be generated by the load circuit 208, for example, based on an expected power consumption of the load circuit 208 in different operation states in a device or an expected power consumption of the load circuit 208 that depends on the device in which the power supply circuit 200 is employed. In some examples, the operation mode signal 244 may be generated internal to the power supply circuit 200, based on a detected change or level of power consumption.

In another example (not shown), a fourth switch may be employed to selectively couple the first inductor 212 to the first node 216. In this example, the first inductance L1 may be the inductance L₂₁₂ of the first inductor, with the first inductor 212 coupled to the first node 216 and the second inductor 214 uncoupled from the first node 216 in the first operation mode. In the second operation mode, the second inductance L2 may be the inductance L₂₁₄ of the second inductor 214, with the first inductor 212 uncoupled from the first node 216 and the second inductor 214 coupled to the first node 216. In this example, the power management circuit 210 generates the first current I₂₁₆ to the load node 204 exclusively through the second inductor 214.

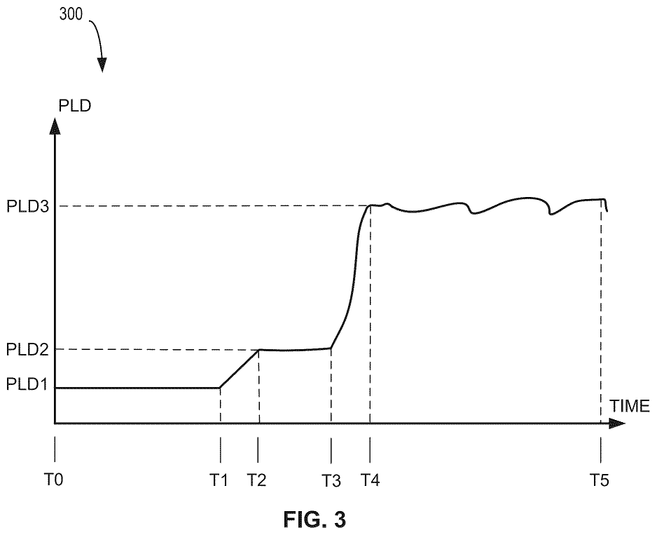

FIG. 3 is a graphical representation (graph) 300 of a rate of power consumption PLD over time in a load circuit that may be the load circuit 208 in FIG. 2. Indicated on the graph 300 are time segments in which the power consumption PLD remains approximately constant or transitions from one level to another. The power supply circuit 200 may be employed in a first operation mode in which power may be efficiently provided at a first power level or in a second operation mode that is better for responding to an increasing power demand. As noted above, the first operation mode and the second operation mode are distinguished from each other by a difference in inductance, which determines a rate of increase in current, which further determines a total charge on a load node, such as the load node 204 in FIG. 2. Higher inductance in the first operation mode provides better power efficiency but poorer transient response than the lower inductance in the second operation mode.

The graph 300 extends over time segments beginning at time T0 and continuing beyond time T5, representing different states of operation of a device. In a first time segment from time T0 to time T1, the power consumption PLD remains constant at a first level PLD1. Due to the consistent level of power demand, power efficiency is more beneficial in the first time segment than transient response. Therefore, in this example, the power supply circuit 200 may operate at the first power level (e.g., with higher inductance) during the first time segment. However, in the next time segment, from time T1 to time T2, the rate of power consumption PLD increases from PLD1 to PLD2, which requires better transient response in the power supply circuit 200. In this situation, power efficiency is compromised for an improvement in the transient response. Thus, the power supply circuit 200 may switch to the second operation mode in which power is supplied at a faster rate. From time T2 to time T3, the power demands remain constant at PLD2, so the first operation mode is selected to provide power more efficiently.

During the time segment from time T3 to time T4, the power consumption PLD again increases significantly from PLD2 to PLD3, which is achieved more efficiently in the second operation mode of the power supply circuit 200 providing better transient response. In the final segment shown in the graph 300, from time T4 to time T5, even though the power level PLD3 is much higher than in PLD1 and PLD2, the power consumption PLD of the load circuit 208 remains relatively constant. Thus, the power supply circuit 200 may remain in the first operation mode to provide the power level PLD3 more efficiently than in the second operation mode.

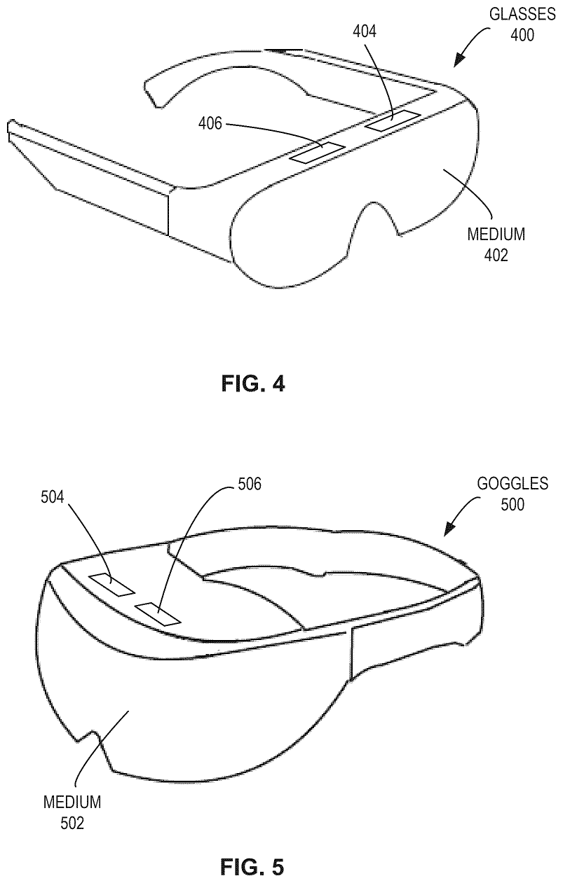

FIGS. 4 and 5 are illustrations of optical devices, which may be extended reality (XR) devices. XR devices include augmented reality (AR) devices and virtual reality (VR) devices. In FIG. 4, glasses 400 have a medium 402 which may be a lens, on which data is presented. The glasses 400 include a data processing circuit 404 configured to process optical data and generate the resulting processed optical data on the medium 402 for a user. The glasses 400 also include a power supply circuit 406, which may be the power supply circuit 200 in FIG. 2. The data processing circuit 404 and the power supply circuit 406 may be disposed on separate integrated circuits (ICs), as shown in FIG. 4, or may be integrated into a single IC. A user of the glasses 400 may have a view through the medium 402 and have that view augmented (e.g., superimposed upon) by optical data processed in the data processing circuit 404.

In contrast to FIG. 4, FIG. 5 is an illustration of goggles 500 which may be a VR device. The goggles 500 include a medium 502 which may be opaque. Accordingly, all optical information seen by the user on the medium 502 may be generated optical data that is processed in a data processing circuit 504. Thus, to meet optical requirements, the data processing circuit 504 processes data at a much higher rate than the data processing circuit 404 in the optical glasses 400. The higher (first) level of data processing causes a higher level of power consumption that may be more efficiently handled by a power supply circuit 506 at the higher operation mode. Employing more efficient operation allows the battery life of the goggles 500 to be greater than if the power supply circuit 506 in the goggles 500 was operated in the second operation mode (e.g., at a lower power level). More efficient power generation also reduces the generation of heat in the data processing circuit 504, which may increase user comfort of a user of the goggles 500.

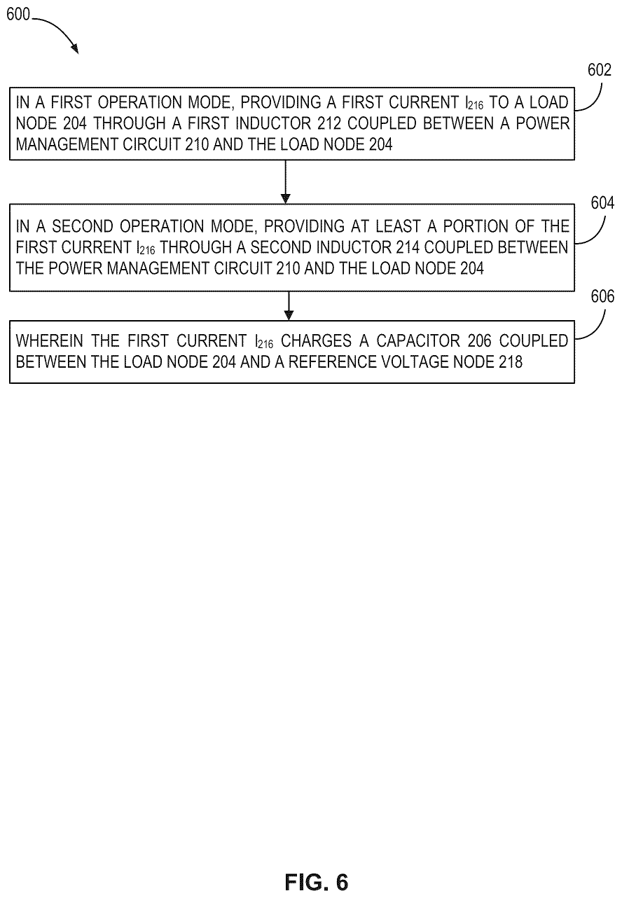

FIG. 6 is a flowchart of a method 600 in a power supply circuit 200. The method 600 includes, in a first operation mode, providing a first current I₂₁₆ to a load node 204 through a first inductor 212 coupled between a power management circuit 210 and the load node 204 (block 602) and, in a second operation mode, providing at least a portion of the first current I₂₁₆ through a second inductor 214 coupled between the power management circuit 210 and the load node 204 (block 604), wherein the first current I₂₁₆ charges a capacitor 206 coupled between the load node 204 and a reference voltage node 218 (block 606).

Examples of such processor-based devices, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, laptop computer, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, an avionics system, a drone, and a multicopter.

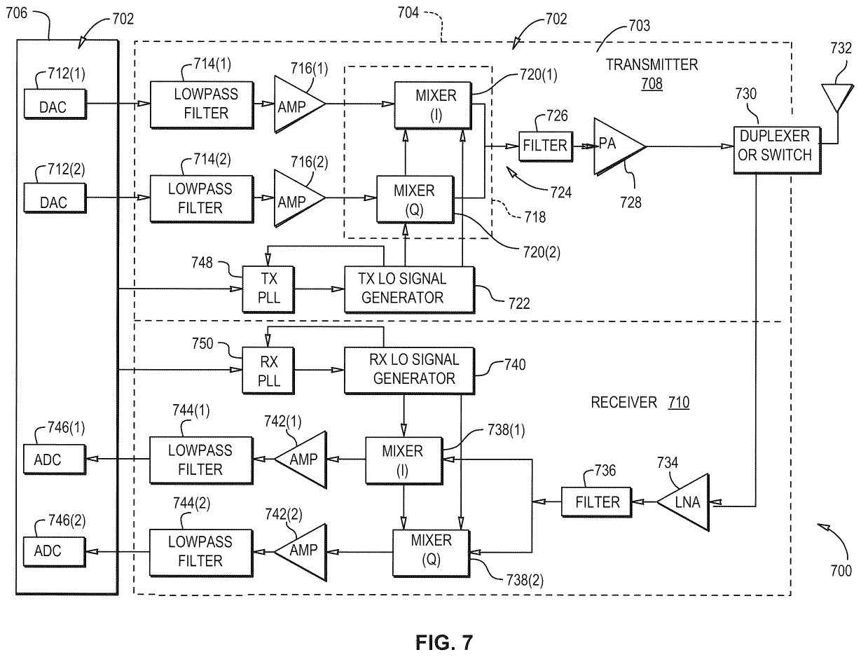

FIG. 7 illustrates an exemplary wireless communications device 700 that includes radio-frequency (RF) components formed from one or more ICs 702, wherein any of the ICs 702 may include a power supply circuit to transfer power from a DC power supply to a load circuit with a first inductance in a first operation mode for efficiency at a first power level and with a second inductance in a second operation mode for efficient operation at a second power level, as illustrated in FIG. 2. The wireless communications device 700 may include or be provided in any of the above-referenced devices, as examples. As shown in FIG. 7, the wireless communications device 700 includes a transceiver 704 and a data processor 706. The data processor 706 may include a memory to store data and program codes. The transceiver 704 includes a transmitter 708 and a receiver 710 that support bi-directional communications. In general, the wireless communications device 700 may include any number of transmitters 708 and/or receivers 710 for any number of communication systems and frequency bands. All or a portion of the transceiver 704 may be implemented on one or more analog ICs, RF ICs (RFICs), mixed-signal ICs, etc.

The transmitter 708 or the receiver 710 may be implemented with a super-heterodyne architecture or a direct-conversion architecture. In the super-heterodyne architecture, a signal is frequency-converted between RF and baseband in multiple stages, for example, from RF to an intermediate frequency (IF) in one stage and then from IF to baseband in another stage for the receiver 710. In the direct-conversion architecture, a signal is frequency-converted between RF and baseband in one stage. The super-heterodyne and direct-conversion architectures may use different circuit blocks and/or have different requirements. In the wireless communications device 700 in FIG. 7, the transmitter 708 and the receiver 710 are implemented with the direct-conversion architecture.

In the transmit path, the data processor 706 processes data to be transmitted and provides I and Q analog output signals to the transmitter 708. In the exemplary wireless communications device 700, the data processor 706 includes digital-to-analog converters (DACs) 712(1), 712(2) for converting digital signals generated by the data processor 706 into the I and Q analog output signals (e.g., I and Q output currents) for further processing.

Within the transmitter 708, lowpass filters 714(1), 714(2) filter the I and Q analog output signals, respectively, to remove undesired signals caused by the prior digital-to-analog conversion. Amplifiers (AMPs) 716(1), 716(2) amplify the signals from the lowpass filters 714(1), 714(2), respectively, and provide I and Q baseband signals. An upconverter 718 upconverts the I and Q baseband signals with I and Q transmit (TX) local oscillator (LO) signals through mixers 720(1), 720(2) from a TX LO signal generator 722 to provide an upconverted signal 724. A filter 726 filters the upconverted signal 724 to remove undesired signals caused by the frequency up-conversion as well as noise in a receive frequency band. A power amplifier (PA) 728 amplifies the upconverted signal 724 from the filter 726 to obtain the desired output power level and provides a transmit RF signal. The transmit RF signal is routed through a duplexer or switch 730 and transmitted via an antenna 732.

In the receive path, the antenna 732 receives signals transmitted by base stations and provides a received RF signal, which is routed through the duplexer or switch 730 and provided to a low noise amplifier (LNA) 734. The duplexer or switch 730 is designed to operate with a specific receive (RX)-to-TX duplexer frequency separation, such that RX signals are isolated from TX signals. The received RF signal is amplified by the LNA 734 and filtered by a filter 736 to obtain a desired RF input signal. Down-conversion mixers 738(1), 738(2) mix the output of the filter 736 with I and Q RX LO signals (i.e., LO_I and LO_Q) from an RX LO signal generator 740 to generate I and Q baseband signals. The I and Q baseband signals are amplified by AMPs 742(1), 742(2) and further filtered by lowpass filters 744(1), 744(2) to obtain I and Q analog input signals, which are provided to the data processor 706. In this example, the data processor 706 includes analog-to-digital converters (ADCs) 746(1), 746(2) for converting the analog input signals into digital signals to be further processed by the data processor 706.

In the wireless communications device 700 of FIG. 7, the TX LO signal generator 722 generates the I and Q TX LO signals used for frequency up-conversion, while the RX LO signal generator 740 generates the I and Q RX LO signals used for frequency down-conversion. Each LO signal is a periodic signal with a particular fundamental frequency. A TX phase-locked loop (PLL) circuit 748 receives timing information from the data processor 706 and generates a control signal used to adjust the frequency and/or phase of the TX LO signals from the TX LO signal generator 722. Similarly, an RX PLL circuit 750 receives timing information from the data processor 706 and generates a control signal used to adjust the frequency and/or phase of the RX LO signals from the RX LO signal generator 740.

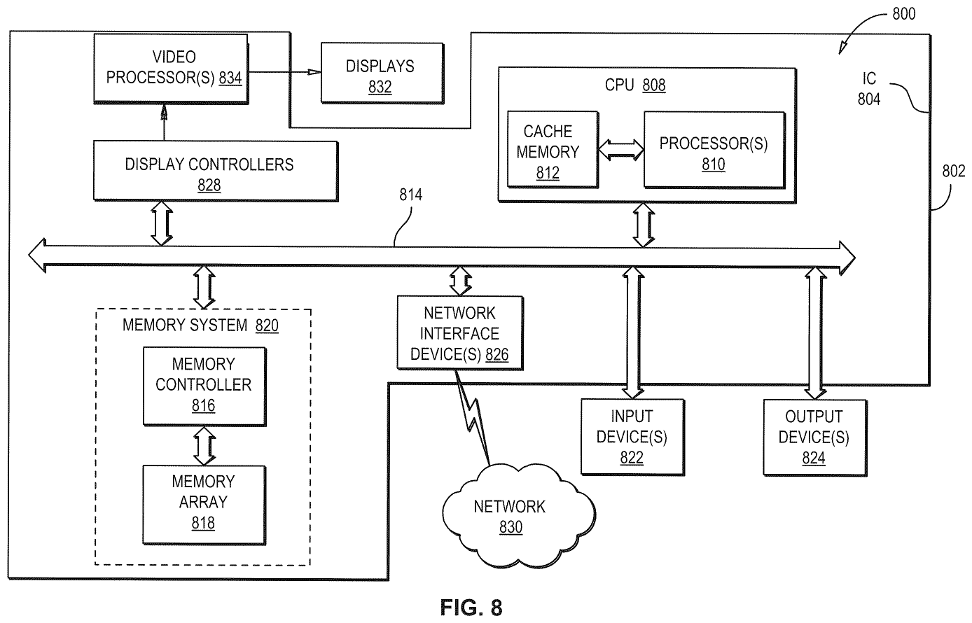

In this regard, FIG. 8 illustrates an example of a processor-based system 800 that can include a power supply circuit to transfer power from a DC power supply to a load circuit with a first inductance in a first operation mode for efficiency at a first power level and with a second inductance in a second operation mode for efficient operation at a second power level, as shown in FIG. 2. The processor-based system 800 includes a central processing unit (CPU) 808 that includes one or more processors 810, which may also be referred to as CPU cores or processor cores. The CPU 808 may have cache memory 812 coupled to the CPU 808 for rapid access to temporarily stored data. The CPU 808 is coupled to a system bus 814 and can intercouple master and slave devices included in the processor-based system 800. As is well known, the CPU 808 communicates with these other devices by exchanging address, control, and data information over the system bus 814. For example, the CPU 808 can communicate bus transaction requests to a memory controller 816, as an example of a slave device. Although not illustrated in FIG. 8, multiple system buses 814 could be provided, wherein each system bus 814 constitutes a different fabric.

Other master and slave devices can be connected to the system bus 814. As illustrated in FIG. 8, these devices can include a memory system 820 that includes the memory controller 816 and a memory array(s) 818, one or more input devices 822, one or more output devices 824, one or more network interface devices 826, and one or more display controllers 828, as examples. The input device(s) 822 can include any type of input device, including, but not limited to, input keys, switches, voice processors, etc. The output device(s) 824 can include any type of output device, including, but not limited to, audio, video, other visual indicators, etc. The network interface device(s) 826 can be any device configured to allow an exchange of data to and from a network 830. The network 830 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 826 can be configured to support any type of communications protocol desired.

The CPU 808 may also be configured to access the display controller(s) 828 over the system bus 814 to control information sent to one or more displays 832. The display controller(s) 828 sends information to the display(s) 832 to be displayed via one or more video processor(s) 834, which processes the information to be displayed into a format suitable for the display(s) 832. The display(s) 832 can include any type of display, including, but not limited to, a cathode ray tube (CRT), a liquid crystal display (LCD), a plasma display, a light emitting diode (LED) display, etc.

Those of skill in the art will further appreciate that the various illustrative logical blocks, modules, circuits, and algorithms described in connection with the aspects disclosed herein may be implemented as electronic hardware, instructions stored in memory or in another computer-readable medium wherein any such instructions are executed by a processor or other processing device, or combinations of both. The devices and components described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from and write information to the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

It should be understood that the terms “first,” “second,” “third,” etc., where used herein, are relative terms that may be used to distinguish between similarly named elements and are not meant to limit or imply a strict orientation and/or order unless otherwise specified. It should also be understood that that the terms “top,” “upper,” “above,” and “bottom,” “lower,” “below,” where used herein, are relative terms and are not meant to limit or imply a strict orientation. A “top” or “upper” or “above” referenced element does not always need to be oriented to be above a “bottom,” or “lower,” or “below” referenced element with respect to ground, and vice versa. An element referenced as “top,” “upper,” “above,” or “bottom,” “lower,” “below,” may be on top or bottom relative to that example only and the particular illustrated example. An element referenced as “top” or “upper” or “above” “bottom,” “lower,” “below,” another element does not have to be with respect to ground, and vice versa. An element referenced as “top” or “upper” or “above” may be above or below such other referenced element, relative to that example only and the particular illustrated example. For example, if a particular object that is discussed as at “top,” or “upper” or “above” another object, and such particular object is flipped 180 degrees, then such particular object would then be oriented as at “bottom,” or “lower” or “below” such other object.

Further, an object being “adjacent” as discussed herein relates to an object being beside or next to another stated object. Adjacent objects may not be directly physically coupled to each other. An object can be directly adjacent to another object which means that such objects are directly beside or next to the other object without another object or layer being intervening or disposed between the directly adjacent objects. An object can be indirectly or non-directly adjacent to another object which means that such objects are not directly beside or directly next to each other, but there is an intervening object or layer disposed between the non-directly adjacent objects.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

Implementation examples are described in the following numbered clauses:
1. An integrated circuit (IC) comprising a power supply circuit comprising:
   a power management circuit configured to conduct a first current through a first node;
   a first inductor coupled between the first node and a load node;
   a second inductor coupled between the first node and the load node; and
   a capacitor coupled between the load node and a reference voltage node;
   wherein the power management circuit is configured to:
      in a first operation mode, generate the first current through the first inductor to the load node; and
   in a second operation mode, generate at least a portion of the first current through the second inductor to the load node.
2. The IC of clause 1, wherein the power management circuit is further configured to generate the first current exclusively through the first inductor in the first operation mode.
3. The IC of clause 1 or clause 2, wherein the power management circuit is further configured to generate the first current to the load node through the first inductor and the second inductor in parallel in the second operation mode.
4. The IC of any of clause 1 to clause 3, the power management circuit comprising:
   a first switch configured to selectively couple a supply voltage node to the first node; and
   a second switch configured to selectively couple the first node to the reference voltage node.
5. The IC of clause 4, wherein the power management circuit is further configured to:
   in a charging mode, control the first switch to couple the supply voltage node to the first node and control the second switch to uncouple the first node from the reference voltage node; and
   in a discharging mode, control the first switch to uncouple the supply voltage node from the first node and control the second switch to couple the first node to the reference voltage node.
6. The IC of clause 4 or clause 5, wherein:
   the power management circuit further comprises a first terminal coupled to the first node;
   the first inductor is coupled to the first terminal;
   the power supply circuit further comprises a third switch configured to selectively couple the second inductor to the first terminal; and
   the power management circuit is configured to generate a switch control signal through a second terminal to control operation of the third switch.
7. The IC of clause 6, wherein the power management circuit is further configured to:
   control the third switch to uncouple the first node from the second inductor in the first operation mode; and
   control the third switch to couple the first node to the second inductor in the second operation mode.
8. The IC of clause 4, the power management circuit further comprising:
   a first terminal coupled to the first node;
   a second terminal; and
   a third switch configured to selectively couple the first node to the second terminal,
   wherein the first terminal of the power management circuit is coupled to the first inductor and the second terminal of the power management circuit is coupled to the second inductor.
9. The IC of clause 8, wherein the power management circuit is further configured to:
   control the third switch to uncouple the first node from the second terminal in the first operation mode; and
   control the third switch to couple the first node to the second terminal in the second operation mode.
10. The IC of any of clause 1 to clause 9, the power management circuit further comprising a third terminal configured to receive an operation mode signal indicating one of the first operation mode and the second operation mode.
11. The IC of any of clause 2 and clause 10, wherein the power management circuit is further configured to, in the second operation mode, generate the first current to the load node exclusively through the second inductor.
12. The IC of clause 1 integrated into a device selected from the group consisting of: a set-top box; an entertainment unit; a navigation device; a communications device; a fixed location data unit; a mobile location data unit; a global positioning system (GPS) device; a mobile phone; a cellular phone; a smartphone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; an avionics system; a drone; and a multicopter.
13. A method of a power supply circuit, comprising:
   in a first mode, providing a first current to a load node through a first inductor coupled between a first terminal of a power management circuit and the load node; and
   in a second mode, providing at least a portion of the first current through a second inductor coupled between the first terminal of the power management circuit and the load node;
   wherein the first current charges a capacitor coupled between the load node and a reference voltage node.
14. An extended reality (XR) device comprising:
   a viewing medium;
   a data processing circuit configured to:
      generate optical data; and
      display the optical data on the viewing medium; and
   a power supply circuit, comprising:
      a power management circuit configured to generate a first current through a first terminal;
      a first inductor coupled between the first terminal and a load node;
      a second inductor coupled between the power management circuit and the load node; and
      a capacitor coupled between the load node and a reference voltage node;
   wherein:
      the power management circuit is configured to:
         in a first operation mode, generate the first current to the load node through the first inductor; and
         in a second operation mode, generate at least a portion of the first current to the load node through the second inductor; and
      the data processing circuit is coupled to the load node and configured to receive the first current.
15. The XR device of clause 14, wherein the power management circuit is further configured to provide the first current exclusively through the first inductor in the first operation mode.
16. The XR device of clause 14 or clause 15, wherein the power management circuit is further configured to generate the first current to the load node through the first inductor and the second inductor in parallel in the second operation mode.
17. The XR device of any of clause 14 to clause 16, the power management circuit comprising:
   a first switch configured to selectively couple a supply voltage node to a first terminal; and
   a second switch configured to selectively couple the first terminal to the reference voltage node.
18. The XR device of clause 17, wherein the power management circuit is further configured to:
   in a charging mode, control the first switch to selectively couple the supply voltage node to the first terminal and control the second switch to uncouple the first terminal from the reference voltage node; and
   in a discharging mode, control the first switch to uncouple the supply voltage node from the first terminal and control the second switch to couple the first terminal to the reference voltage node.
19. The XR device of clause 17 or clause 18, wherein:
   the power supply circuit further comprises a third switch configured to selectively couple the second inductor to the first terminal of the power management circuit; and
   the power management circuit further comprises a second terminal coupled to the third switch,
   wherein the power management circuit is configured to generate a switch control signal through the second terminal to control operation of the third switch.
20. The XR device of clause 17, the power management circuit further comprising:
   a second terminal coupled to the second inductor; and
   a third switch configured to selectively couple the first terminal to the second terminal.

What is claimed is:

1. An integrated circuit (IC) comprising a power supply circuit comprising:
a power management circuit configured to conduct a first current through a first node;
a first inductor coupled between the first node and a load node;
a second inductor coupled between the first node and the load node; and
a capacitor coupled between the load node and a reference voltage node;
wherein the power management circuit is configured to:
in a first operation mode, generate the first current through the first inductor to the load node; and
in a second operation mode, generate at least a portion of the first current through the second inductor to the load node.

2. The IC of claim 1, wherein the power management circuit is further configured to generate the first current exclusively through the first inductor in the first operation mode.

3. The IC of claim 2, wherein the power management circuit is further configured to generate the first current to the load node through the first inductor and the second inductor in parallel in the second operation mode.

4. The IC of claim 1, the power management circuit comprising:
a first switch configured to selectively couple a supply voltage node to the first node; and
a second switch configured to selectively couple the first node to the reference voltage node.

5. The IC of claim 4, wherein the power management circuit is further configured to:
in a charging mode, control the first switch to couple the supply voltage node to the first node and control the second switch to uncouple the first node from the reference voltage node; and
in a discharging mode, control the first switch to uncouple the supply voltage node from the first node and control the second switch to couple the first node to the reference voltage node.

6. The IC of claim 4, wherein:
the power management circuit further comprises a first terminal coupled to the first node;
the first inductor is coupled to the first terminal;
the power supply circuit further comprises a third switch configured to selectively couple the second inductor to the first terminal; and
the power management circuit is configured to generate a switch control signal through a second terminal to control operation of the third switch.

7. The IC of claim 6, wherein the power management circuit is further configured to:
control the third switch to uncouple the first node from the second inductor in the first operation mode; and
control the third switch to couple the first node to the second inductor in the second operation mode.

8. The IC of claim 4, the power management circuit further comprising:
a first terminal coupled to the first node;
a second terminal; and
a third switch configured to selectively couple the first node to the second terminal,
wherein the first terminal of the power management circuit is coupled to the first inductor and the second terminal of the power management circuit is coupled to the second inductor.

9. The IC of claim 8, wherein the power management circuit is further configured to:
control the third switch to uncouple the first node from the second terminal in the first operation mode; and
control the third switch to couple the first node to the second terminal in the second operation mode.

10. The IC of claim 1, the power management circuit further comprising a third terminal configured to receive an operation mode signal indicating one of the first operation mode and the second operation mode.

11. The IC of claim 2, wherein the power management circuit is further configured to, in the second operation mode, generate the first current to the load node exclusively through the second inductor.

12. The IC of claim 1 integrated into a device selected from the group consisting of: a set-top box; an entertainment unit; a navigation device; a communications device; a fixed location data unit; a mobile location data unit; a global positioning system (GPS) device; a mobile phone; a cellular phone; a smartphone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; an avionics system; a drone; and a multicopter.

13. A method of a power supply circuit, comprising:
in a first mode, providing a first current to a load node through a first inductor coupled between a first terminal of a power management circuit and the load node; and
in a second mode, providing at least a portion of the first current through a second inductor coupled between the first terminal of the power management circuit and the load node;
wherein the first current charges a capacitor coupled between the load node and a reference voltage node.

14. An extended reality (XR) device comprising:
a viewing medium;
a data processing circuit configured to:
generate optical data; and
display the optical data on the viewing medium; and
a power supply circuit, comprising:
a power management circuit configured to generate a first current through a first terminal;
a first inductor coupled between the first terminal and a load node;
a second inductor coupled between the power management circuit and the load node; and
a capacitor coupled between the load node and a reference voltage node;
wherein:
the power management circuit is configured to:
in a first operation mode, generate the first current to the load node through the first inductor; and
in a second operation mode, generate at least a portion of the first current to the load node through the second inductor; and
the data processing circuit is coupled to the load node and configured to receive the first current.

15. The XR device of claim 14, wherein the power management circuit is further configured to provide the first current exclusively through the first inductor in the first operation mode.

16. The XR device of claim 14, wherein the power management circuit is further configured to generate the first current to the load node through the first inductor and the second inductor in parallel in the second operation mode.

17. The XR device of claim 14, the power management circuit comprising:
a first switch configured to selectively couple a supply voltage node to a first terminal; and
a second switch configured to selectively couple the first terminal to the reference voltage node.

18. The XR device of claim 17, wherein the power management circuit is further configured to:
in a charging mode, control the first switch to selectively couple the supply voltage node to the first terminal and control the second switch to uncouple the first terminal from the reference voltage node; and
in a discharging mode, control the first switch to uncouple the supply voltage node from the first terminal and control the second switch to couple the first terminal to the reference voltage node.

19. The XR device of claim 17, wherein:
the power supply circuit further comprises a third switch configured to selectively couple the second inductor to the first terminal of the power management circuit; and
the power management circuit further comprises a second terminal coupled to the third switch,
wherein the power management circuit is configured to generate a switch control signal through the second terminal to control operation of the third switch.

20. The XR device of claim 17, the power management circuit further comprising:
a second terminal coupled to the second inductor; and
a third switch configured to selectively couple the first terminal to the second terminal.
